(19) United States
(12) Patent Application Publication
(10) Pub. No.: US 2007/0203893 A1
(43) Pub. Date: Aug. 30, 2007

(54) Apparatus and method for federated querying of unstructured data

(75) Inventors: Anthony Seth Krinsky, Wayne, PA (US); Marcel Hassenforder, Boulogne Billancourt (FR); Marc Chevrier, Nogent Sur Marne (FR); Jean-Yves Cras, Paris (FR)

Correspondence Address: COOLEY GODWARD KRONISH LLP;ATTN: Patent Group, Suite 500, 1200 - 19th Street, NW, Washington, DC, 20036-2402, US

(73) Assignee: Business Objects, S.A., Levallois-Perret (FR)

(21) Appl. No.: 11/364,564

(22) Filed: Feb. 27, 2006

(51) Int. Cl. G06F 17/30

(52) U.S. Cl. 707/3

(57) ABSTRACT

A computer readable medium is configured to receive a query, to map the query to an unstructured data source, to dispatch a request based on the query to the unstructured data source, to aggregate data returned by the unstructured data source in a structured data store, and to issue the query against the structured data store.

### FIELD OF THE INVENTION

The present invention relates generally to searching data stores. More particularly, this invention relates to a technique for applying federated queries to unstructured data.

### BACKGROUND OF THE INVENTION

In recent years, the number and complexity of data stores maintained by large corporations has grown. This proliferation of data, along with the convergence of structured and unstructured information, has rendered ineffective conventional ETL (Extract-Transform-Load) paradigms typically designed to extract, aggregate, and cleanse corporate data into structured information contained in a central repository such as a data mart. To address this shortcoming, a new paradigm, Enterprise Information Integration (EII), uses a federated query system to transparently integrate multiple distributed data sources into one consolidated information resource. This consolidation potentially enables a single client to access on demand many autonomous data sources. However, EII does not yet provide uniform search capabilities across all data sources, as a federated querying system that can fully address both structured and unstructured data has yet to be realized.

Federated query engines accept client requests for data using grammars like Structured Query Language (SQL) and XQuery, parse these requests—informed by meta-data about back-end data sources, relationships between them, and additional query planning information—and then dispatch requests to these data sources. The data sources return data to the EII framework. This data may be forwarded to the requestor directly or may be provided to an intermediary database, such as a relational database management system (RBDMS) or object-oriented database management system (OODBMS), where post-processing occurs to prepare data for the requester. Post-processing includes but is not limited to shaping, grouping, and joining disparate data.

The requests brokered by EII tools are often complex. SQL and other query languages are complex and require considerable effort for database vendors to implement. Using SQL, for example, it is possible to issue multiple SELECT requests and UNION them together, have selects within selects, perform many kinds of joins, and combine criteria with nested Boolean operators. Moreover, the same SQL statement can be phrased in many different ways.

Structured data sources can parse a query in a language such as SQL and return a row set, which is an ordered set of rows of the same kind with each row being composed of a fixed list of columns. For EII vendors, supporting structured data sources can be challenging but is not conceptually difficult to understand. The initial request is parsed and for each source, one or more query statements are issued in a choreographed sequence that returns the exact data or a super-set of data matching the initial request. Additional filtering and manipulation then occurs in the post-processing stage.

Supporting unstructured data sources, however, is considerably more challenging. Unstructured data sources have interfaces such as procedural, parameterized interfaces that do not understand a query in a language such as SQL. These interfaces may include standard Java objects, enterprise Java beans (EJBs), or Webservices. In the EII marketplace, there are three primary approaches to using such unstructured data sources in a federated query system, all of which have significant limitations. The first approach is the use of stored procedures. Many EII vendors do not permit the querying of unstructured data using free-hand queries from the client. Rather, the underlying procedural interfaces are translated directly into database stored procedures. The problem with this approach is that many EII tools do not support querying stored procedures directly, resulting in the inability to combine data from structured and unstructured sources in a query statement. Moreover, joining disparate data sources, using scalar functions to manipulate column values, and shaping, grouping or otherwise manipulating results, are not supported. This significantly limits the desired transparency of EII tools across both structured and unstructured data sources.

The second approach invokes stored procedures in-line, such as by using SQL custom functions that can be evaluated to individual column values in another SQL statement. This approach, while allowing the combination of data from structured and unstructured data sources in a query statement, does not permit returning more than a single tuple of data from the unstructured data source. For simple problems like returning a row set of current prices for a set of stocks, this paradigm works. However, more complex operations such as joining disparate data sources are generally not supported, limiting the search capabilities available to clients.

The third approach passes a query statement like that provided to structured data sources, or a binary representation of a parsed expression tree for the query statement, to a query translator that converts the query into procedures that underlying unstructured data sources can understand. The problem with this approach is that it tries to deal with the problem of query complexity by “passing the buck” to the implementer of the unstructured data provider to write translator code to handle complex queries or complex parsed tree structures derived from queries. This imposes the complexities and costs of creating different custom interface drivers for each unstructured data source on the implementers of the unstructured data sources.

To address these shortcomings, it would be desirable to provide a solution for federated querying of unstructured data that enables the querying of unstructured data using free-hand queries from the client, that supports advanced query capabilities such as joining, shaping and grouping, and that permits rapid integration of unstructured data sources without the need for custom drivers for unstructured data sources.

### SUMMARY OF THE INVENTION

This invention includes a computer readable memory to direct a computer to function in a specified manner. In one embodiment, the computer-readable medium comprises instructions to receive a query; to map the query to an unstructured data source; to dispatch a request based on the query to the unstructured data source; to aggregate data returned by the unstructured data source in a structured data store; and to issue the query against the structured data store. The computer-readable medium may further comprise instructions to create a simplified query based on the query, to parse the simplified query, and to select the unstructured data source based on the simplified query. The computer-readable medium may further comprise instructions to find dependencies of the simplified query on the unstructured data source, to generate candidate execution plans that resolve the dependencies, to select a lowest cost execution plan from the candidate execution plans, and to use the lowest cost execution plan to obtain the data returned by the unstructured data source.

In another embodiment, the computer-readable medium comprises instructions to receive a query; to map the query to a structured data source and an unstructured data source; to dispatch requests based on the query, including a first request to the structured data source and a second request to the unstructured data source; to aggregate data returned by the structured data source and the unstructured data source in a structured data store; and to issue the query against the structured data store.

### BRIEF DESCRIPTION OF THE DRAWINGS

For a better understanding of the nature and objects of the invention, reference should be made to the following detailed description taken in conjunction with the accompanying drawings, in which:

FIG. 1 illustrates an enterprise information integration system including a federated query engine containing both structured and unstructured data driver functions, in accordance with one embodiment of the present invention.

FIG. 2 illustrates an enterprise information integration system including a federated query engine, which is configured in accordance with one embodiment of the present invention.

FIG. 3 illustrates operations associated with processing a query of data sources including at least one unstructured data source, in accordance with one embodiment of the present invention.

FIG. 4 illustrates modeling of an unstructured data source as a table that can be queried by a federated query engine through the use of parameter columns, in accordance with one embodiment of the present invention.

FIG. 5 illustrates operations associated with mapping a query to an unstructured data source, in accordance with one embodiment of the present invention.

FIG. 6 illustrates operations associated with generating an execution plan for a query of an unstructured data source, in accordance with one embodiment of the present invention.

### DETAILED DESCRIPTION OF THE INVENTION

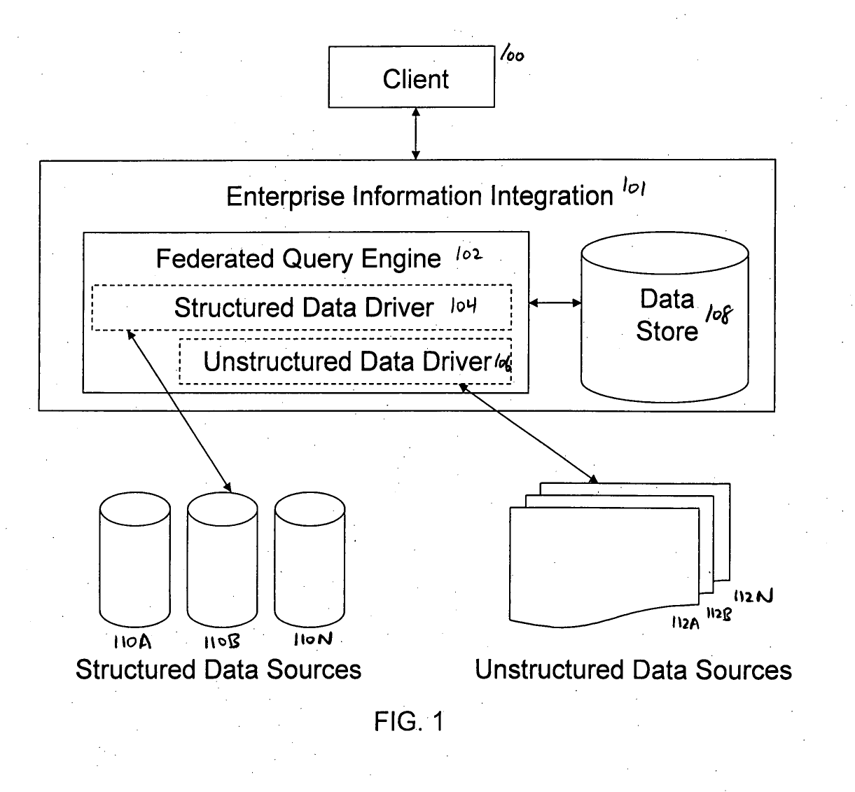

FIG. 1 illustrates an enterprise information integration (EII) system 101 including a federated query engine 102 containing both structured data driver 104 and unstructured data driver 106 functions, in accordance with one embodiment of the present invention. A client 100 makes a query request for data using a grammar such as SQL or XQuery to the EII system 101. The federated query engine 102 processes the client query. Based on the results of the query processing, the federated query engine 102 may issue one or more requests via software performing the function of one or more data drivers, which may be represented as a structured data driver 104 and an unstructured data driver 106. Each data driver serves the function of an abstraction layer between middleware of the federated query engine 102 and the specific characteristics of interfaces to structured data sources 110 (110A, 110B, and 110N in this example) and unstructured data sources (112A, 112B, and 112N in this example). Requests issued via the structured data driver 104 may be in the form of query statements mapped to a standard interface such as an Open Database Connectivity (ODBC) interface, a Java Database Connectivity (JDBC) interface, or a programmatic interface to the structured data sources 110. Requests issued via the unstructured data driver 106 may be in the form of parameterized procedure calls to the unstructured data sources 112. The structured data source 110 has the computational capability to parse the query statements issued by the federated query engine 102, while the unstructured data source 112 does not have this computational capability. The structured data source 110 and the unstructured data source 112 may process these requests in parallel. The structured data source 110 and the unstructured data source 112 return tabular row sets or hierarchical data to the federated query engine 102 via the structured data driver 104 and the unstructured data driver 106, respectively. The federated query engine 102 may insert this data into a structured data store 108, which may be a RDBMS or an OODBMS, and may then issue the client query against the data store 108.

An important principle underlying the EII system architecture shown in FIG. 1 is that the unstructured data sources 112 do not require a custom query translator to translate the query statements to requests using the procedural interface of the unstructured data sources 112. Rather, this function is provided by the federated query engine 102, and can be thought of as enabling the unstructured data driver 106. This use of standard interfaces without custom query translators enables the rapid integration of unstructured data sources, which is an important benefit given the rapid proliferation of data sources such as electronic mail, word processing documents, and web pages that are composed primarily if not completely of unstructured data.

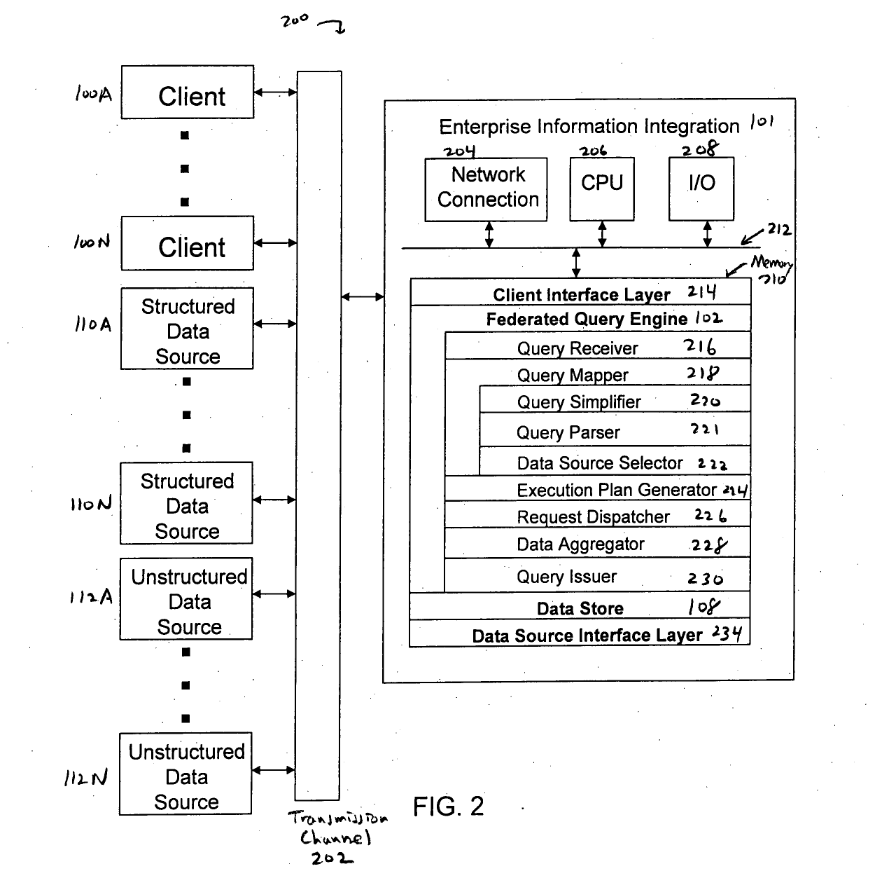

FIG. 2 illustrates the EII system 101 including a federated query engine 102, which is configured in accordance with one embodiment of the present invention. A network 200 includes the EII system 101, which may communicate via a transmission channel 202 with a set of client computers 100A-100N, a set of structured data sources 110A-110N, and a set of unstructured data sources 112A-112N. The EII system 101 may reside on the same computer with a subset of one or more clients 100, one or more structured data sources 110, and one or more unstructured data sources 112, or may reside on a separate computer. The EII system 101 includes standard components, such as a network connection 204, a CPU 206, and an input/output module 208, which communicate over a bus 212. A memory 210 is also connected to the bus 212. The memory 210 stores a set of executable programs that are used to implement the functions of the invention. The client computers 100, the structured data sources 110, and the unstructured data sources 112 include the same standard components.

In an embodiment of the invention, the memory 210 stores executable instructions establishing a client interface layer 214, the federated query engine 102, a data store 108, and a data source interface layer 234. The federated query engine 102 has modules including a query receiver 216, a query mapper 218, an execution plan generator 224, a request dispatcher 226, a data aggregator 228, and a query issuer 230. The query mapper 218 has modules including a query simplifier 220, a query parser 221, and a data source selector 222.

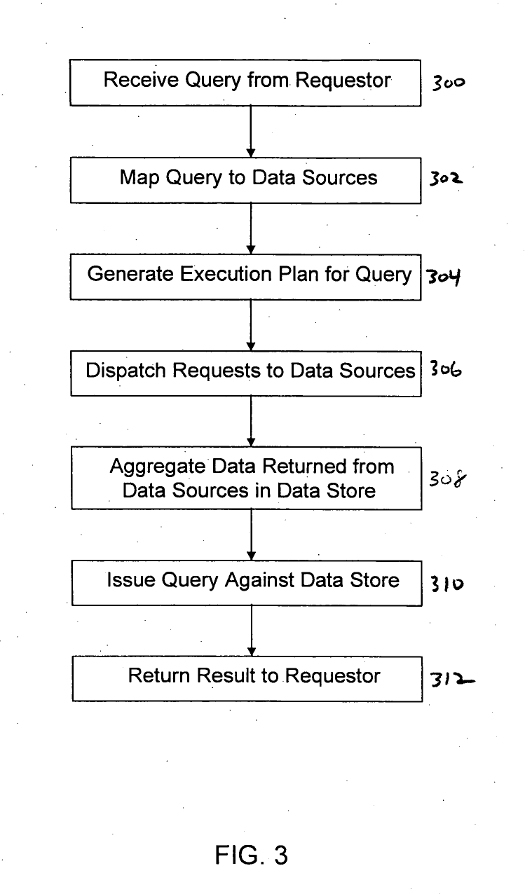

FIG. 3 illustrates operations associated with processing a query of data sources including at least one unstructured data source, in accordance with one embodiment of the present invention. The EII system 101 receives an input query from client 100 at the client interface layer 214 (block 300). The client interface layer 214 may provide services including user interface services and security services to the client 100, and may utilize protocols such as the Hypertext Transfer Protocol (HTTP) for communication with the client 100. The client interface layer 214 passes the contents of the input query to the query receiver 216 of the federated query engine 102 over an interface such as an ODBC or a JDBC interface. The query receiver may store the input query contents in a request queue until the query mapper 218 is ready to process the input query.

The query mapper 218 then maps the input query to data sources that may include structured data sources 110 and unstructured data sources 112 (block 302). In one embodiment, the input query may be factored into components including a first query component to be applied to the structured data source 110 and a second query component to be applied to the unstructured data source 112. The query simplifier 220 may simplify the input query directly, if not factored into components, or may simplify a query component. The purpose of the query simplification is to convert the input query or query component into a simplified form where procedures (software methods or functions) or web services (that take parameters as input) of unstructured data sources 112 can be queried as a table or set of tables referenced by one or more simplified queries. This reduces the amount of complex logic needed in unstructured data sources 112. Each simplified query may return a superset of the information requested by the input query. The query parser 221 may then parse the simplified query to determine the query elements of the simplified query, such as SQL selects, filters, and joins, the tables referenced by the simplified query, and references to portions of the tables such as column identifiers. The data source selector 222 determines the data sources impacted, the data to be requested from the data sources, and potential ways of requesting the data from the data sources. The data source selector 222 may map table names and column identifiers to method or function calls (including associated input parameters of such method or function calls) that collect some or all of the data to be requested from unstructured data sources 112, and may provide these method or function calls to the execution plan generator 224. In another embodiment, the data source selector 222 may map table names and column identifiers to structured data sources 110.

The execution plan generator 224 then generates the execution plan for the query (block 304). The purpose of generating an execution plan is to determine an order of table processing that ensures that each table is invoked only when dependencies on other tables are resolved. In one embodiment, the simplistic strategy of processing tables in their order of appearance in the simplified query is used. In another embodiment, the tables may be processed in an order that minimizes a cost metric. For unstructured data sources 112, the execution plan includes a series of one or more method or function calls with associated input parameters. For structured data sources 110, the execution plan includes a series of one or more queries in a grammar such as SQL.

Based on the execution plan, the request dispatcher 226 then dispatches requests via the data source interface layer 234 to data sources that may include structured data sources 110 and unstructured data sources 112 (block 306). The data source interface layer 234 is an integration layer that performs any further translations, such as protocol translations, required to enable communication between the federated query engine 102, the structured data sources 110, and the unstructured data sources 112. The data aggregator 228 then aggregates row set data returned from the structured data sources 110 and the unstructured data sources 112 as a temporary structured store in the data store 108 (block 308). Various performance optimizations related to indexing or refactoring may be made at this stage. The query issuer 230 then issues the input query, or possibly the simplified query if semantically equivalent, against the temporary structured store in the data store 108 (block 310). The federated query engine 102 then returns the result to the client 100 via the client interface layer 214 (block 312).

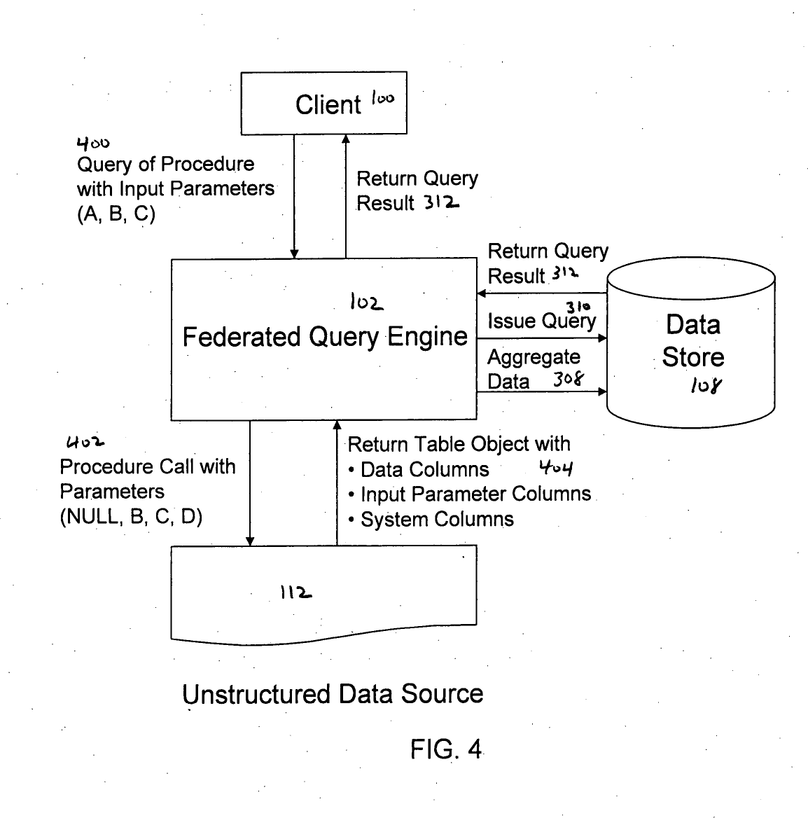

FIG. 4 illustrates modeling of an unstructured data source 112 as a table that can be queried by a federated query engine 102 through the use of parameter columns, in accordance with one embodiment of the present invention. Parameter columns are a unique method for invoking parameterized procedure calls using a query grammar such as SQL, and enable the federated query engine 102 to perform the function of an unstructured data driver 106 as described in FIG. 1. Parameter columns enable the return of a table object from unstructured data sources 112 based on the mapping of an input query to unstructured data sources 112 performed by the query mapper 218 of FIG. 3. The client 100 can specify an arbitrary procedure such as CUSTOMER_INQUIRY in a query using a grammar such as SQL (block 400). For example, a sales representative (client 100) needs to search the corporate email system (unstructured data source 112) for online customers asking for a price quote on WidgetX. The sales representative executes the input query
SELECT*FROM CUSTOMER_INQUIRY WHERE Date<=2005-05-01 AND BodyText=‘WidgetX’ AND Subject=‘Price Quote’

The corporate email system has the procedural interface CUSTOMER_INQUIRY(A, B, C, D) exposed to the federated query engine 102, with A representing the parameter DateReceived, B representing the parameter BodyText, C representing the parameter Subject, and D representing MaxRows (block 402). CUSTOMER_INQUIRY may not be designed to handle the operator “<=”; if so, the value 2005-05-01 of input parameter A can be ignored and NULL would be passed instead, resulting in CUSTOMER_INQUIRY returning data without any date range restriction. Input parameters B and C are passed as part of the call of CUSTOMER_INQUIRY. System parameter D has special meaning to CUSTOMER_INQUIRY, as D specifies the maximum number of rows of data that can be returned by CUSTOMER_INQUIRY. D is therefore supplied by the federated query engine 102 and passed as part of the call of CUSTOMER_INQUIRY, even though D is not an input parameter obtained from the input query, and may have a value independent of the input query.

In response to the procedure call CUSTOMER_INQUIRY(NULL, B, C, D), the unstructured data source 112 returns a table object with data columns, input parameter columns, and system columns (block 404). The table object may be a row set which can be degenerated to a list of values or to a single value. The data columns include data returned by the procedure call to the unstructured data source 112, such as customer names, addresses, and contact information in the case of CUSTOMER_INQUIRY. The input parameter columns include the input parameters A, B, and C, with values parsed from the input query or in another embodiment, the simplified query output from the query simplifier 220. (Note that the parameter column method is equally applicable to simple input queries such as that from this example, as well as more complex queries that include operations such as in-line queries and SQL UNIONs.) The system columns include, in this case, the system parameter D, with a value provided by the federated query engine 102.

If an input parameter for a procedure such as CUSTOMER_INQUIRY is not specified in the input query, then the federated query engine 102 may provide a default value for the parameter. In another embodiment, there may be a system parameter that has special meaning to the federated query engine 102 because, for example, the system parameter sets a default value or otherwise impacts the handling of parameter columns at the federated query engine 102. This system parameter, though provided by the client 100 in the input query, does not affect the input query and evaluates to TRUE at runtime. Such system parameters may be identified by a prefix such as “SYS_”. In certain instances, dummy data is returned for parameter columns. The dummy data provides structure that allows certain clients to re-query data.

In one embodiment, metadata is registered with the federated query engine 102 describing the capabilities of the unstructured data source 112. In this example, the metadata includes the columns returned by the procedure CUSTOMER_INQUIRY, the default values for parameter columns if not specified in the input query, and system parameters with special meaning to the federated query engine 102.

After the table object is returned to the federated query engine 102 (block 404), then as described in FIG. 3, the data aggregator 228 of the federated query engine 102 aggregates the table object to the temporary structured store in the data store 108 (block 308), the query issuer 230 issues the input query against the temporary structured store in the data store 108 (block 310), and the federated query engine 102 returns the result to the client 100 via the client interface layer 214 (block 312 of FIG. 3).

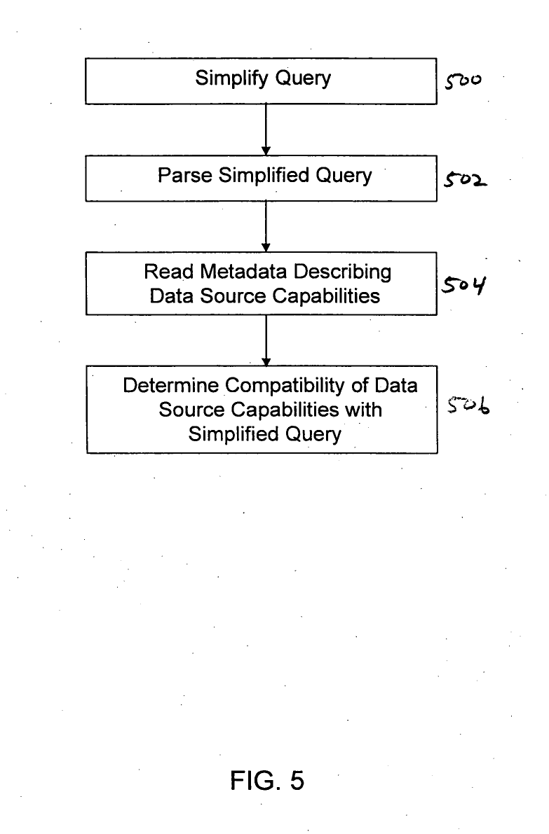

FIG. 5 illustrates operations associated with mapping a query to an unstructured data source as performed by the query mapper 218, in accordance with one embodiment of the present invention. In one embodiment, the input query is first simplified (block 500) by refactoring the query to simplify criteria expressions (such as SQL conditions including filters and joins) for unstructured data sources 112, so that the simplified query contains at maximum a one-dimensional map of criteria expressions. The input query is rewritten to factor out Boolean “OR” fragments in criteria expressions (using SQL UNION queries, for instance), and to express all conditions simply using “AND” operators to avoid the need to pass complex, hierarchical conditional trees to unstructured data providers 112, which typically have procedural interfaces. The simplified query is a union of queries of the form:

SELECT Columns, Expressions (Columns)

FROM Tables

WHERE Simple Filter 1

AND . . .

AND Simple Filter N

AND Simple Join 1

AND . . .

AND Simple Join P

AND <Complex Condition>

GROUP BY Columns

ORDER BY Columns

The system enforces complex conditions such as expression computations, groups, and sorts by issuing the input query against the data store 108 (block 310). As such, only the following query is executed:

SELECT Columns (Directly expressed)+Columns (In Expression)

FROM Tables

WHERE Simple Filter 1

AND . . .

AND Simple Filter N1

AND Simple Join 1

AND . . .

AND Simple Join P1

In the above query, SimpleFilter X is of the form Column=Value or of the form Column IN {List of Values}. The set of simple filters {Simple Filter 1 . . . Simple Filter N1} is a subset of the filters given by the input query. SimpleJoin Y is of the form TableN.ColumnM=TableP.ColumnQ. The set of simple joins {Simple Join 1 . . . Simple Join P1} is a subset of the joins given by the input query.

The simplified query is then parsed (block 502). In this embodiment, parsing includes determination of the list of columns required by SQL SELECT statements and SQL expressions, the list of columns required by SQL joins and filters, the list of simple parameters made available from simple filters, and the list of joins in which the table is a part. Joins are between two tables, coming from the same or different data sources. Filters are generally applied on one table column to restrict the value of this column to one constant, a set of constant values, or an interval of values.

For each SQL SELECT statement in the rewritten query, the simplified query is decomposed to extract table names and their associated column names and a one-dimensional map of criteria expressions (possibly many per column) such as COL1=6 and COL2 BETWEEN 12 AND 20. Other information including scalar functions and shaping are ignored and saved for post-processing, such as when the input query is issued against the data store 108 (block 310 of FIG. 3).

Metadata describing the capabilities of the unstructured data source 112 is then read (block 504). This metadata models input and output parameters to data sources by defining the mapping between a procedure name and a table name, or by defining an implied mapping between a procedure name and the table name, the output column requested, and the parameters passed as input to the procedure. In one embodiment, to be queried through a query using a grammar such as SQL, a procedure must fit in a Table or a Set of Tables model. These two models are defined below for an SQL query:
A Table:
   Receives as Input:
      a list of columns to output
      a set of conditions passed through filters and joins. These conditions are of the form:
         column=value
         column IN (value-1, . . . , value-N)
         column>value
         expression <compare> value
   And outputs:
      A row set which:
         has the general form of a flat table composed of rows and columns
         but which can be degenerated as a single column (list of values of the same kind)
         or a single value (outputs a single row and single column)
A Set of Tables:
   Receives as Input:
      a list of columns to output
      a set of conditions passed through filters and joins. These conditions are of the form:
         column=value
         column IN (value-1, . . . , value-N)
         column>value
         expression <compare> value
      a set of joins between the tables modeling the relationship that exists between those tables
   And outputs:
      A row set which:
         has the general form of a flat table composed of rows and columns
         but which can be degenerated as a single column (list of values of the same kind)
         or a single value (outputs a single row and single column)

The list of required parameters for a procedure may be detailed in the metadata. If modeled as a table or a set of tables, a procedure will be invoked based on the mapping to the table or the set of tables defined in the metadata. The metadata defines the correspondence between a procedure with one or more input parameters and one or more output parameters, and a query with references to one or more tables and with one or more filters and joins. The input parameters, output parameters, and values in the filters and joins can be a single value (through filter COLUMN=Value) or a list of values (through filter COLUMN IN (List) (and joins)). Each value can be of type String, Integer, Date, or Decimal (Float), and needs to be parsed from the parameters received through the query.

In the case of function overloads, the mapping between a table and the underlying methods depends on the columns to be retrieved. The parameters to be passed must be detailed in the metadata. If a required parameter to a function is not present when the function is called, then a default value for this parameter is assigned (or an error can be generated).

After the metadata is read, the compatibility of data source capabilities with the simplified query is determined (block 506). The list of candidate procedures for each data source that output required columns determined by the parsing of the simplified query (block 502) is determined.

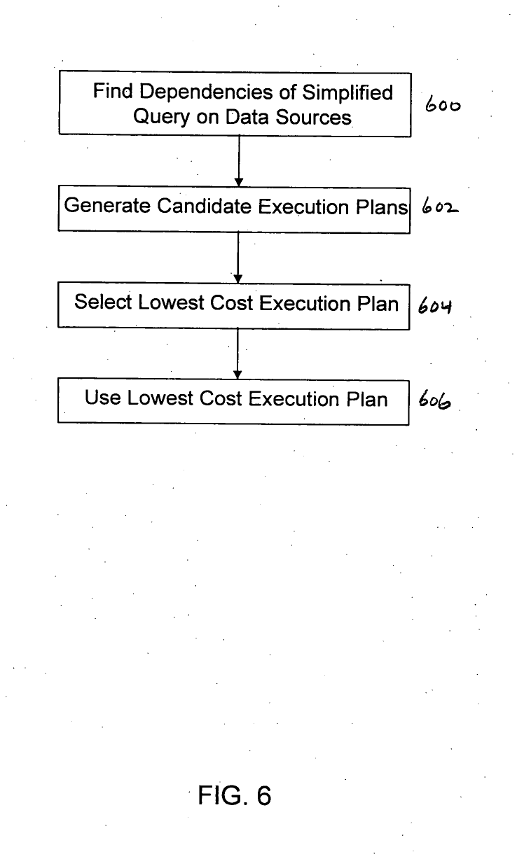

FIG. 6 illustrates operations associated with generating an execution plan for a query of an unstructured data source 112, in accordance with one embodiment of the present invention. The execution plan generator 224 finds the dependencies of the simplified query on unstructured data sources (block 600). Based on the dependencies, the execution plan defines the order in which candidate procedures (determined in block 506 of FIG. 5) are called. If no order can be found, then a suitable error is generated to inform users that the query can not be executed. For example, if a procedure receives a required parameter C1 through a join T1.C1=T2.C2, then the value for table/procedure T2 must be retrieved before T1 can be called, i.e. the dependency T1 depends on T2.

Once dependencies are identified, then an execution plan, e.g., a. topological sort, can be generated that resolves all of the dependencies. An example of the identification of dependencies and the generation of an execution plan is given below.

There are two functions:
Function: StockQuote:
   Input Parameters: Date, StockId
   Output Parameters: Value
Function: Portifolio:
   Input Parameters: UserId
   Output Parameters: StockId, Qty
And a query:
   SELECT StockId, Qty, Value
   FROM StockQuote, Portfolio
   WHERE UserId=‘JohnDoe’
   AND Date=‘1/1/1967’

Inside the given query, the function StockQuote depends on the function Portfolio. It is necessary to get the input parameter StockId given by function Portfolio (i.e. JohnDoe's portfolio) before getting the Value for the StockId and Date. The execution plan is as follows—note that there is no lowest cost optimization of the execution plan in this example.

Vector<StockId, Qty> = Portfolio ( ‘JohnDoe’ )

For Each StockId

Value = StockQuote ( ‘1/1/1967’, StockId );

In one embodiment, lowest cost optimization of the execution plan is performed. A process for performing this optimization includes the generation of candidate execution plans (block 602) and the selection of a lowest cost execution plan (block 604). An aggregate cost is determined for each candidate execution plan, and the execution plan selected for use may be the lowest cost execution plan (block 606). An example of such a process is given below. This process is designed so that, for each stage, the procedure is used which best leverages the parameters available, i.e. which are compatible with the output columns. The invocation of a table is delayed until all parameters are available through filters and joins.

Initialization

Create an empty list of candidates for the execution plan.

STAGE 1

For each Table of Queries:
For each compatible Table implementation
   Create an execution plan, having:
      UsedTable=<Table>
      STEP 1=<Table Implementation>
      Cost=Estimated Cost of Table Implementation*cardinality of call
   Add this execution plan to the list of candidate execution plans for STEP 1
      STAGE P, P<=N Number of Tables

Create an Empty list of execution plans for <STEP P>

Browse the list of execution plans established for STEP <P-1>:

For each execution plan <EBasePlan>defined for STEP <P-1>
For each Table <T> of Query not already used in Execution Plan <EBasePlan>
   For each compatible Table implementation <TI>
      Create an execution plan <ENewPlan>, having:
         UsedTable=<UsedTable By EBasePlan>+<Table>
         STEP 1 TO P-1=<STEP 1 TO P-1 of EBasePlan>
         STEP P of E=TI
         Cost=<Cost Of EBasePlan>+Estimated Cost of TI*Estimated cardinality of call
      Add this execution plan to the list of candidate execution plans for STEP P
         Termination at End of STAGE N, N=Number of Tables

The process is divided into stages, where at each intermediate stage a list of candidate execution plans is generated. At each stage, a set of dependencies is resolved, and candidate execution plans generated at each stage build on the set of candidate execution plans from the previous stage. At each stage, the number of candidate execution plans to be considered is limited. This is done by sorting the candidate execution plans and keeping only the N best candidates.

Each candidate execution plan corresponds to a compatible table implementation, i.e. one or more candidate procedures, where an implementation is compatible with a stage if the implementation is both compatible with the parameters available and returns required columns. The cost of an individual procedure call to each implementation needs to be defined for each procedure in the metadata based on, for example, an estimated time of execution of the procedure call. The cardinality of a call is P if the implementation needs to be called P times (for example, if the query filters contain an IN LIST for a parameter). The cardinality of a call can be approximated, in the case of SQL joins, as the approximate cardinality of rows coming from the source table. (This can be approximated from the number of rows of the source table divided by the number of distinct values on filtered columns.) This information can be updated manually or automatically by simply measuring the time for execution of method calls and using SELECT COUNT and SELECT DISTINCT COUNT queries to determine cardinalities.

From the foregoing, it can be seen that an apparatus and method for federated querying of unstructured data are described. The foregoing description, for purposes of explanation, used specific nomenclature to provide a thorough understanding of the invention. It will be appreciated, however, that embodiments of the invention can be in other specific forms without departing from the spirit or essential characteristics thereof. The described embodiments are not intended to be exhaustive or to limit the invention to the precise forms disclosed; obviously, many modifications and variations are possible in view of the above teachings. The presently disclosed embodiments are, therefore, considered in all respects to be illustrative and not restrictive. The embodiments were chosen and described in order to best explain the principles of the invention and its practical applications; they thereby enable others skilled in the art to best utilize the invention and various embodiments with various modifications as are suited to the particular use contemplated. It is intended that the following claims and their equivalents define the scope of the invention.

What is claimed is:

1. A computer readable medium comprising executable instructions to:
receive a query;
map said query to an unstructured data source;
dispatch a request based on said query to said unstructured data source;
aggregate data returned by said unstructured data source in response to said request in a structured data store; and
issue said query against said structured data store.

2. The computer readable medium of claim 1 wherein said query is in a Structured Query Language (SQL) format.

3. The computer readable medium of claim 1 wherein said unstructured data source includes textual objects included in electronic mail documents, word processing documents, and web pages.

4. The computer readable medium of claim 1 wherein the executable instructions to map include executable instructions to:
create a simplified query based on said query;
parse said simplified query; and
select said unstructured data source based on said simplified query.

5. The computer readable medium of claim 4 further comprising executable instructions to generate an execution plan for said simplified query that resolves dependencies of said simplified query on said unstructured data source, wherein said request is based on said execution plan.

6. The computer readable medium of claim 4 wherein the executable instructions to select said unstructured data source include executable instructions to:
read metadata describing capabilities of said unstructured data source; and
determine compatibility between said unstructured data source and said simplified query.

7. The computer readable medium of claim 4 wherein an input parameter of said unstructured data source is a value parsed from said simplified query.

8. The computer readable medium of claim 6 wherein said data returned by said unstructured data source is a row set including a parameter column and a data column.

9. The computer readable medium of claim 8 wherein said parameter column is based on said input parameter.

10. The computer readable medium of claim 8 wherein said data returned by said unstructured data source further includes a system column with a value independent of said database query.

11. The computer readable medium of claim 4, further comprising executable instructions to:
find dependencies of said simplified query on said unstructured data source;
generate candidate execution plans that resolve said dependencies;
select a lowest cost execution plan from said candidate execution plans; and
use said lowest cost execution plan to obtain said data returned by said unstructured data source.

12. The computer readable medium of claim 11 wherein the executable instructions to generate include executable instructions to:
create a first set of candidate execution plans that resolves a first set of said dependencies; and
create a second set of candidate execution plans that resolves a second set of said dependencies by building on said first set of candidate execution plans.

13. The computer readable medium of claim 11 wherein the executable instructions to generate include executable instructions to determine candidate data sources available to said candidate execution plans, wherein each of said candidate data sources resolves at least one of said dependencies.

14. The computer readable medium of claim 11 wherein the executable instructions to select include executable instructions to determine the aggregate cost of each of said candidate execution plans.

15. The computer readable medium of claim 14 wherein said aggregate cost is based on cost of a method call, and on cardinality of said method call.

16. A computer readable medium comprising executable instructions to:
receive a query;
map said query to a structured data source and an unstructured data source;
dispatch requests based on said query, including a first request to said structured data source and a second request to said unstructured data source;
aggregate data returned by said structured data source and said unstructured data source in response to said requests in a structured data store;
issue said query against said structured data store.

17. The computer readable medium of claim 16 wherein said requests are processed in parallel by said structured data source and said unstructured data source.

18. The computer readable medium of claim 16 wherein the executable instructions to map include executable instructions to factor said query into components including a first query to be applied to said structured data source and a second query to be applied to said unstructured data source.

19. The computer readable medium of claim 18 further comprising executable instructions to generate an execution plan for said second query that resolves dependencies of said second query on said unstructured data source, wherein said second request to said unstructured data source is based on said execution plan.

20. The computer readable medium of claim 19 wherein the executable instructions to generate include executable instructions to:
generate candidate execution plans that resolve said dependencies;
select a lowest cost execution plan from said candidate execution plans; and
use said lowest cost execution plan to obtain said data returned by said unstructured data source.
